(19) United States
(12) Patent Application Publication
(10) Pub. No.: US 2007/0104267 A1
(43) Pub. Date: May 10, 2007

(54) Method for handling content information

(76) Inventors: Michael Meyer, Sibbesse (DE); Hans-Juergen Busch, Buechenbach (DE); Klaus Stuhlmueller, Zirndorf (DE)

Correspondence Address: MICHAEL J. STRIKER, 103 EAST NECK ROAD, HUNTINGTON, NY, 11743, US

(21) Appl. No.: 11/591,404

(22) Filed: Nov. 1, 2006

(30) Foreign Application Priority Data
Nov. 4, 2005 (DE) 10 2005 053 148.2

(51) Int. Cl. H04B 1/66

(52) U.S. Cl. 375/240

(57) ABSTRACT

A method for handling content information has the steps of carrying out the method using at least one device in a network, carrying out a video content analysis to provide content information for video data, and accumulating the content information in different hierarchal levels; and also a device for handling content information, a network which includes the device, a computer program with program codes to carry out all steps of the method in the device or in the network, and a computer program with program codes stored on a computer-readable storage device to carry out the method in the device of the invention, are proposed.

### CROSS-REFERENCE TO A RELATED APPLICATION

The invention described and claimed hereinbelow is also described in German Patent Application DE 102005053148.2 filed on Nov. 4, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a method for handling content information, a device, a network, a computer program, and a computer program product.

In security electronics, devices are known in the field of video monitoring which analyze a video signal and deliver data regarding the scenes and, therefore, content information, to the video signals. Devices of this type can be operated in networks. The MPEG-7 or MPEG-4 international standards used to describe metadata are extremely complex, however.

### SUMMARY OF THE INVENTION

Accordingly, it is an object of the present invention to provide a method for handling content information, a device for handling content information, a network, a computer program, and a computer program product in accordance with the invention.

In keeping with these objects and with others which will become apparent hereinafter, one feature of the present invention resides, briefly stated, in a method for handling content information, comprising the steps of carrying out the method using at least one device in a network; carrying out a video content analysis to provide content information for video data; and accumulating the content information in different hierarchal levels.

Another feature of the present invention resides, briefly stated, in a device for handling content information in a network, comprising means for accumulating content information for video data in different hierarchal levels.

Also, a network which includes the above mentioned device in accordance with the present invention, a computer program with program code means to carry out all steps of the inventive method, and a computer program with program code means which are stored in a computer readable data storage device to carry out all steps of the inventive method are proposed.

The inventive method for handling content information is carried out using at least one device in a network. Video content analysis is carried out to provide content information for video data, and this content information is accumulated in different hierarchical levels.

The inventive device is designed to accumulate content information for video data in different hierarchical levels.

The inventive network includes at least one inventive device and is designed to carry out a method according to the present invention.

The present invention also relates to a computer program product with program code means to carry out all steps of an inventive method when the computer program is run on a computer or a related arithmetic unit, in particular in an inventive device or in an inventive network.

The present invention also relates to a computer program product with program code means, which are stored on a computer-readable data storage device, to carry out all steps of an inventive method when the computer program is run on a computer or a related arithmetic unit, in particular in an inventive device or in an inventive network.

The proposed invention is preferably suitable for a network-like video monitoring system which includes at least one device for evaluating video data or signals. This video monitoring system can also include at least one unit for depicting and storing video data and content information. Several devices and units of this type can be interconnected using the network according to the present invention. The evaluation can take place in a device designed as a camera or, in particular, in a device designed as a multimedia device.

With the present invention it is now possible to combine the content information in a structured manner, via accumulation in the hierarchical levels, and, particularly advantageously, to prepare and/or code it, in order to transfer, display, and/or store it in a network in which the at least one device is connected with at least one unit. Inventive devices can also be interconnected within the network.

The content information is accumulated for transfer and/or storage in different hierarchical levels or layers which contain the various information, content information in particular, and it is stored in these hierarchical levels.

With block-based accumulation, information about regions within images or blocks of video data in which something has changed can be made available. In other hierarchical levels, information about objects which have been discovered in at least one image within the video data, and their trajectories, can be made available. This is object-based accumulation. When accumulation is carried out for event detection, information about events that occur in one scene can be made available. A scene of this type is, e.g., an object which goes or has gone from a first region into a second region within a sequence of images. In addition, at least one hierarchical level can be provided for overview information, which combines—in a compressed manner—the data on events, objects, and image changes over large periods of time, i.e., content information.

With the present invention, data, such as video data, and content information can be coded for purposes of transfer and storage such that the data from the various hierarchical levels can be read independently of each other. It is therefore possible to provide devices and/or units designed as receivers, which can interpret only a subset of information. It is also possible that existing receivers can continue to read data they are aware of, even when new hierarchical levels are added.

Using coding provided by the present invention, it is also possible to send data to several receivers simultaneously, every receiver having the capability to connect into a data stream made available in this manner, at any point in time. As a result of the coding, data, content information in particular, from lower hierarchical levels can also be compressed into overview information in higher hierarchical levels and therefore also accumulated. This overview information can be advantageously used to search for relevant events in order to limit a review of image archives of video data to short, relevant periods of time.

When carried out, the inventive method can be supported with a suitable data format, a video content description format (VCD). By using a data format of this type, a related protocol is used to transfer data, i.e., video data and/or content information.

The inventive device is designed to make content information available for video data when video content analysis is carried out, and to accumulate this content information in different hierarchical levels. With this device, it is therefore possible to carry out any steps of an inventive method. In one embodiment, this device can be designed to accumulate content information received via a network in higher hierarchical levels and to forward it immediately and/or with time delay to another device or a multimedia unit. According to this embodiment, it is also possible with this device to make hierarchical levels available without coupling to video content analyses.

Further advantages and embodiments of the present invention result from the description and the attached drawing.

It is understood that the features mentioned above and to be described below can be used not only in the combination described, but also in other combinations or alone without leaving the framework of the present invention.

The present invention is depicted schematically with reference to an exemplary embodiment in the drawing, and it is described in detail below with reference to the drawing.

### BRIEF DESCRIPTION OF THE DRAWINGS

FIG. 1 shows a preferred embodiment of a network, in a schematic illustration in accordance with the present invention.

FIG. 2 shows a schematic diagram of a preferred embodiment of an inventive method in a video monitoring system.

FIG. 3 shows an overview of a preferred layout of hierarchical levels in accordance with the present invention.

FIG. 4 shows an example of the use of frame information and level information tags in accordance with the present invention.

### DESCRIPTION OF THE PREFERRED EMBODIMENTS

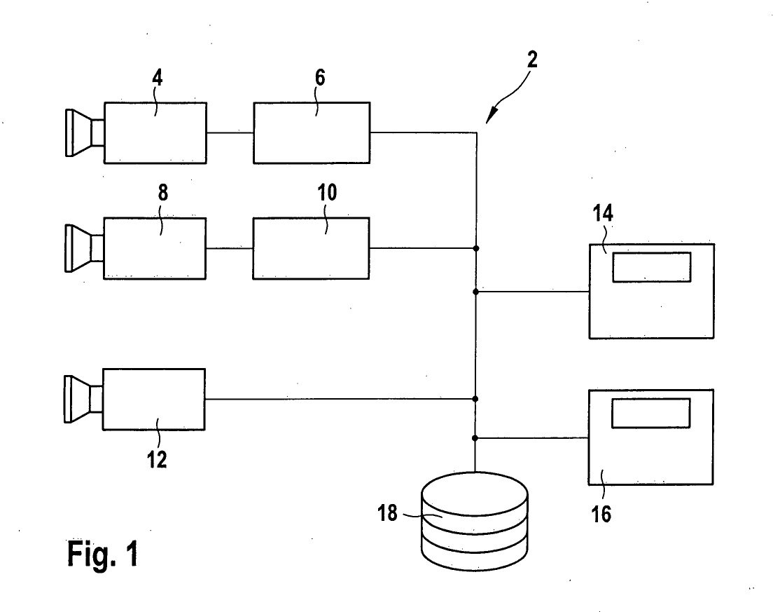

FIG. 1 shows a network 2 with a first unit 4, which is designed as a camera and is connected with a first device 6, which is designed as an evaluation unit, and a second unit 8, which is also designed as a camera and is connected with a second device 10, which is also designed as an evaluation unit. A third device 12 includes a camera and an evaluation unit. User interfaces are provided as the third and fourth units 14, 16 of network 2, which is depicted here in a preferred configuration. A fifth unit 18 is designed as a memory in this case. All devices 6, 10, 12 and units 4, 8, 14, 16, 18 are interconnected in a network 2.

Units 4, 8 designed as cameras, and device 12, which includes the camera, are designed to record video data. Devices 6, 10, 12, which are designed as evaluation units or which include an evaluation unit, are designed to evaluate the recorded video data. It is provided that content information which provides information about changes that occurred in the images depicted by the video data can be extracted from the video data and thereby made available. This content information is accumulated in different hierarchical levels. Certain bits of content information are accumulated in hierarchical levels provided therefor.

Content information from lower hierarchical levels is accumulated in lower resolutions in higher hierarchical levels, thereby providing overview-type summaries of the content information.

The video data and content information, which has been combined in the hierarchical levels in an accumulated or structured manner, is forwarded via network 2 to units 14, 16, which are designed as user interfaces, and to unit 18, which is designed as a memory. The content information and video data are stored in unit 18, which is designed as a memory, for any period of time.

Using units 14, 16, which are designed as user interfaces, users can access the video data and content information at any time. To obtain an initial, rough overview of the events depicted in the video data, the users can first view higher hierarchical levels, in which the content information has been accumulated in low resolution as overview information and, if it is expected that special events are depicted, users can view high-resolution, accumulated content information from lower hierarchical levels, to obtain an exact picture of the events.

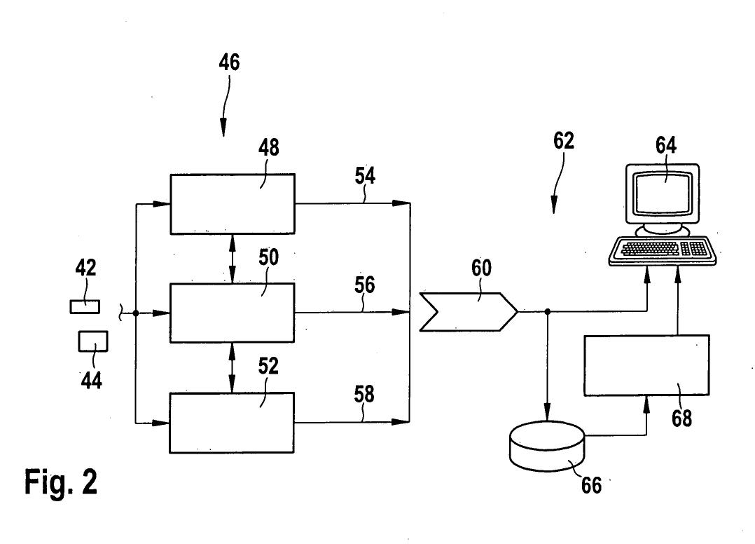

With the process depicted in FIG. 2, it is provided that images 42 from a stream of video data 44 are analyzed within the framework of a video data content analysis 46. Video content analysis 46 includes a block-based analytical component 48, an object-based analytical component 50, and an event-detecting analytical component 52. Video data content analysis 46 is carried out in a device according to the present invention. In video content analysis 46, content information 54, 56, 58 is made available by analytical component 48, 50, 52.

Block-based analytical component 48 is suited for dissecting individual images 42 into blocks, an image 42 being subdivided into rows and columns contained in the individual blocks. Images 42 can be incremented into the smallest blocks necessary, and they can include only one or a few image pixels. It is possible to compare temporally successive images 42 using block-based analytical components 48 preferably automatically via a computer-assisted comparison, and therefore automatically.

A motion map of images 42 of video data 44 is made available via the object-based analytical components, and related content information 54 is therefore accumulated.

Object-based analytical component 50 is connected with block-based analytical component 48 so that information can be exchanged. Object-based analytical component 50 is designed to analyze content information 54 made available by block-based analytical component 48 such that individual objects and the identities of these objects are detected and made available as content information 56, which is depicted here as character boxes. Character boxes of this type provide information about the position, speed, width, height, etc., of detected or identified objects.

It is provided that object-based analytical component 50 exchanges content information 54, 56 with event-detecting or event-displaying analytical component 52. Event-detecting analytical component 52 provides content information 58 that provides information about special events, which document, e.g., loitering persons, lost children, or acts of crime.

Content information 54, 56, 58 made available within the framework of video content analysis 46 is accumulated in hierarchical levels in the inventive devices via a video content description 60. Content information 54, 56, 58 accumulated in the hierarchical levels and video data 44 are made available via a network 62 with units 64, 66, which are designed as computers and memories. Using unit 64, which is designed as a computer, a user can analyze the video data and content information 54, 56, 58 accumulated in the hierarchical levels. User can also access unit 66 designed as a memory at any time; unit 66 makes available—via a device 68 designed as an event data base—prepared images 42 based on content information 54, 56, 58 accumulated in the hierarchical levels.

The format provided by video content description 60 is suited to and useful for providing results, i.e., content information 54, 56, 58, of an algorithm carried out within the framework of video content analysis 46 accumulated over the hierarchical levels, for transfer and storage. Users are therefore provided with an overview-type summary of events contained in video data 44. Content information 54, 56, 58 and, therefore, the depicted results, can be easily decoded and analyzed in unit 64, which is designed as a computer. Due to the structure provided via the hierarchical levels, is it possible to perform a rapid, intelligent search for certain events. Video content description 60 is designed to be flexible, and can be expanded easily with the addition of new features. In addition, using the format to code video data 44 makes is possible to reduce the memory space required for video data 44.

Content information 54, 56, 58 and, therefore, results of the algorithm provided via video content description 60 are defined and coded using the format provided by video content description 60 for transfer and storage in network 62. Content information 54, 56, 58 can be transferred independently of coded video data streams, and can be linked with video data 44 via a real-time transport protocol (RTP) using timing marks. Depending on the configuration of device 68, which is designed as a data base, content information 54, 56, 58 can be stored in context with video data 44, also with consideration for the hierarchical levels.

A grouping of a data stream in up to sixteen or more hierarchical levels is supported by including overview data or information that is accumulated in higher hierarchical levels from content information 54, 56, 58 from lower hierarchical levels. Content information 54, 56, 58 from lower hierarchical levels is combined in low resolution in higher hierarchical levels of this type.

An output of different abstraction levels of the algorithm which provides video content analysis 46 can be described via video content description 60. Video content description 60 also makes it possible to perform an elegant and effective search, in which different temporal resolutions of content information 54, 56, 58 can be selected in an overview, so that a large quantity of data, such as video data 44, can be viewed in summarized form in a short period of time.

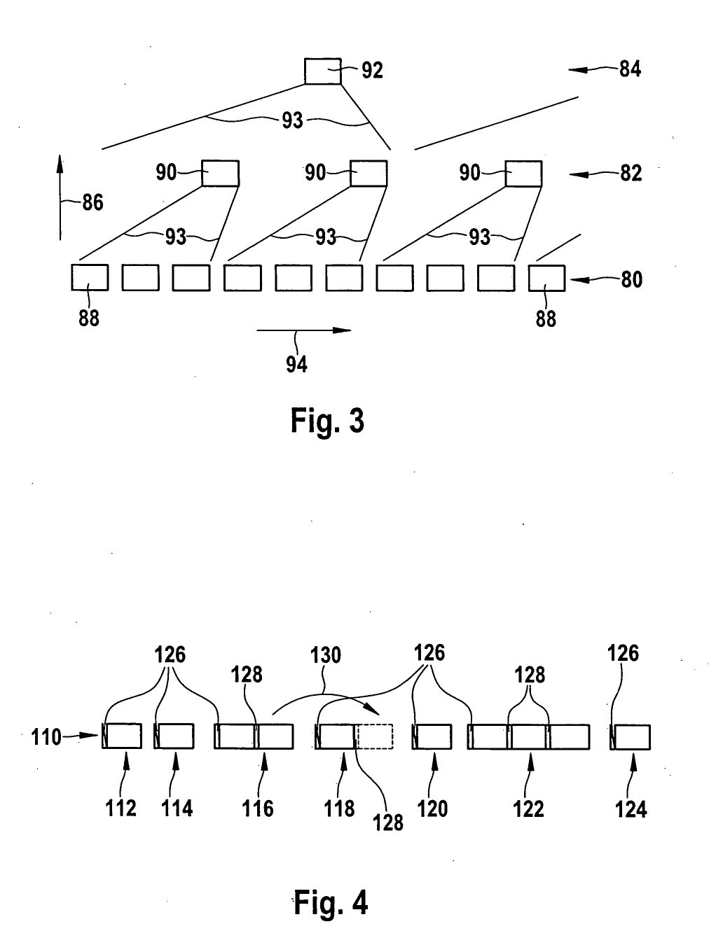

FIG. 3 shows, in a schematic depiction, an overview of a preferred structure of hierarchical levels 80, 82, 84 from bottom to top, in ascending order 86. A hierarchical level 80, which is the lowest, or “0”, includes packets 88 with content information. Only two such packets 88 are labeled with reference numerals, for clarity. It is provided that packets 88 in lowest hierarchical level 80 are combined via accumulation 93 to form packets 90 of content information in the middle (first, in this case) hierarchical level 82. It is also provided that packets 90 of content information in middle hierarchical level 82 are combined via accumulation 93 to form packets 92 of content information at the second (highest, in this case) hierarchical level 84.

All packets 88, 90, 92 are shown in FIG. 3 along a time axis 94. Particular accumulations 93 of packets 88, 90, from lower to higher hierarchical levels 80, 82, 84, include suitable extraction or combination of content information, so that a temporal resolution of content information behaves inversely to an order 86 of hierarchical levels 80, 82, 84. The temporal resolution of the content information in packets 88 in lowest hierarchical level 80 is therefore finer or higher than that of content information accumulated in packets 90 in middle hierarchical level 82. A comparatively rough resolution of content information takes place in hierarchical level 84—which is the highest in this case—for packets 92.

For example, in lowest hierarchical level 80, complete descriptions of objects or events are coded as content information within packets 88, while, in middle hierarchical level 82, content information about objects or events within a particular packet 90 are accumulated per second, and they are accumulated per minute in packets 92 of highest hierarchical level 84.

Since only the highest hierarchical level 84 is viewed, a decoding device can recognize how many objects have been detected within this minute. Accumulations 93 described are defined in this case by an algorithm which provides a video content analysis and/or a video content description. A format provided by the video content description is therefore designed as a packet-based protocol.

Accordingly, a beginning of a packet 88, 90, 92 must be known in order to analyze the content information. Packet tags which contain the related information are provided for this purpose. These packet tags can be designed as field-describing “headers”. It is therefore possible to easily analyze a stream of video data based on packet tag types. Some of the packet tags can have special significance. For example, a frame information tag can signal the start of a new frame within a data stream, which means that all subsequent packet tags of a particular hierarchical level 80, 82, 84 belong to this frame until the next frame information tag arrives.

In addition, a level information tag can be provided that indicates order 86 and time 94 within the higher hierarchical levels 82, 84, so an overview of a certain time interval can be provided. A level information tag of this type can be used to start a hierarchical search in a first overview at an uppermost hierarchical level and, to obtain more detailed content information, it can scan ahead in a descending manner across the middle hierarchical level 82 into lowest hierarchical level 80.

FIG. 4 shows, in a schematic illustration, an example of the use of frame information and level information tags. In FIG. 4, a number of packets 112, 114, 116, 118, 120, 122, 124 containing content information is depicted within a higher hierarchical level 110. Each of these packets 112, 114, 116, 118, 120, 122, 124 includes a frame information tag 126 at the beginning. In addition, larger packets 116, 118, 122 shown in FIG. 4 also contain level information tags 128. In this higher hierarchical level 110, level information tags 128 in packets 116, 128,122 therefore indicate, e.g., that packets 116, 118 contain repeats 130 of content information.

The protocol provided by the present invention serves to transfer and control data, which are provided according to a video content description. These data are content information for video data, which have been accumulated in different hierarchical levels. It is provided that packets of content information have tags which describe the content and temporally structured sequence of the packets. Tags of this type can also provide information about objects or events. New tags can be assigned to existing packets at any time, thereby ensuring that an expansion can be carried out for future applications.

By using the level information tags, the content information within different hierarchical levels can be structured and made available in different levels of resolution for a quick overview when the user is performing an analysis. As such, it is possible to carry out a quick, intelligent search through a large amount of data provided by the video content description.

It is also feasible to provide tags for different alarms, a motion map, and object property descriptions. These object property descriptions can be expanded with the addition of additional tags. An object description can include alarm identifiers, standstill periods, motion vectors, structural statistics, and shape properties, e.g., character boxes and outlines or contours. For example, the shape and instant when an object was originally discovered can be transferred retroactively, e.g., if an alarm has been triggered.

It will be understood that each of the elements described above, or two or more together, may also find a useful application in other types of methods and constructions differing from the type described above.

While the invention has been illustrated and described as embodied in a method for handling content information, etc., it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for handling content information, comprising the steps of carrying out the method using at least one device in a network; carrying out a video content analysis to provide content information for video data; and accumulating the content information in different hierarchal levels.

2. A method as defined in claim 1, wherein said accumulating the content information in different hierarchal levels includes accumulating the content information in different resolutions; and further comprising compressing the content information from lower hierarchal levels in higher hierarchal levels to provide overview information.

3. A method as defined in claim 1; and further comprising transferring the content information accumulated in the hierarchical levels and storing it in the network; and making bits of content information available independently of each other, so that they can be read.

4. A method as defined in claim 1; and further comprising dividing individual images of video data in the video content analysis into blocks; and registering block-wise changes within a sequence of images and making them available as content information.

5. A method as defined in claim 1; and further comprising making the content information available in a packet-based format for a video content description, so that contents of the video data are recordable and analyzable via the video content description.

6. A method as defined in claim 1; and further comprising subdividing the content information in the hierarchal levels into packets; and labeling the packets with tags.

7. A device for handling content information in a network, comprising means for accumulating content information for video data in different hierarchal levels.

8. A device as defined in claim 7, wherein the device is configured so as to carry out a method for handling content information, comprising the steps of carrying out the method using at least one device in a network, carrying out a video content analysis to provide content information for video data, and accumulating the content information in different hierarchal levels.

9. A device as defined in claim 8; and further comprising means for forwarding the accumulated content information received via a network, to higher hierarchal levels.

10. A network, comprising at lest one device including means for accumulating content information for video data in different hierarchal levels and configured to carryout a method for handling content information including using at least one device in a network, carrying out a video content analysis to provide content information for video data, and accumulating the content information in different hierarchal levels.

11. A computer program with program code means, configured to carry out all steps of a method for handling content information including using at least one device in a network, carrying out a video content analysis to provide content information for video data, and accumulating the content information in different hierarchal levels when the computer program is run on a computer or a related transmitting unit, in particular in a device for handling content information in a network comprising means for accumulating content information for video data in different hierarchal levels, or in a network, comprising at lest one device including means for accumulating content information for video data in different hierarchal levels.

12. A computer program with program code which are stored on a computer-readable data storage device, configured to carry out all steps of a method for handling content information comprising the steps of carrying out the method using at least one device in a network, carrying out a video content analysis to provide content information for video data, and accumulating the content information in different hierarchal levels, wherein the computer program is run on a computer or a related transmitting unit, in a device for handling content information in a network comprising means for accumulating content information for video data in different hierarchal levels or in a network comprising at lest one device including means for accumulating content information for video data in different hierarchal levels.
